(19) United States
(12) Patent Application Publication
(10) Pub. No.: US 2018/0203156 A1
(43) Pub. Date: Jul. 19, 2018

(54) Inventory Monitoring System with Visual Indicator and Associated Methods

(71) Applicant: Wal-Mart Stores, Inc., Bentonville, AR (US)

(72) Inventors: Matthew Allen Jones, Bentonville, AR (US); Aaron Vasgaard, Fayetteville, AR (US); Nicholaus Adam Jones, Fayetteville, AR (US); Robert James Taylor, Rogers, AR (US)

(21) Appl. No.: 15/849,998

(22) Filed: Dec. 21, 2017

Related U.S. Application Data
(60) Provisional application No. 62/445,959, filed on Jan. 13, 2017.

(51) Int. Cl. G01V 8/10; G01L 7/04; G01L 7/18; G06T 7/20; G06T 7/00; G06Q 10/08

(52) U.S. Cl. CPC G01V 8/10; G01L 7/043; G01L 7/045; G06Q 10/087; G06T 7/20; G06T 7/0004; G01L 7/18

(57) ABSTRACT

An item monitoring system including a bladder having a body with a hollow interior configured to be filled with a fluid is described. The system includes an indicator fluidly connected to the hollow interior of the body of the bladder, the indicator including a movable component configured to visually indicate a fullness of the shelf with one or more items in a non-electrical manner. The connection between the indicator and the bladder defines a closed system. Displacement of the fluid from the bladder into the indicator moves the movable component of the indicator to indicate the fullness of the shelf.

### CROSS-REFERENCE TO RELATED APPLICATIONS

This application claims the benefit of co-pending, commonly assigned U.S. Provisional Patent Application No. 62/445,959, which was filed on Jan. 13, 2017. The entire content of the foregoing provisional patent application is incorporated herein by reference.

### BACKGROUND

Taking inventory of items on shelving provides an indication of the number of items disposed on the shelf and may indicate a need for restocking of the shelf. Shelf sensors and video analytics are available in industry to electronically monitor inventory on shelving.

### SUMMARY

Exemplary embodiments of the present invention provide inventory monitoring systems using a bladder filled with a fluid and an indicator fluidly connected to the bladder that includes a movable component configured to visually indicate a status of the inventory on the shelf in a non-electrical manner. The position of the movable component of the indicator within an elongated tube varies based on the compression forces on the bladder from the items disposed on the shelf and the fluid displaced from the bladder, thereby allowing for the inventory status to be displayed without necessitating an energy source. An image capture device (e.g., a camera) can be used to detect the position of the movable component to determine the inventory status on the shelf. The closed system includes low cost components with minimal data processing if an image capture device is implemented, thereby reducing overhead costs for monitoring inventory.

In one embodiment, an exemplary item monitoring system is provided that includes a bladder configured to be positioned on a supporting surface of a shelf and further configured to receive one or more items thereon (directly or indirectly). The bladder includes a body that includes a hollow interior configured to be filled with a fluid. The item monitoring system includes an indicator fluidly connected to the hollow interior of the body of the bladder. The indicator includes a movable component configured to visually indicate a fullness of the shelf with the one or more items in a non-electrical manner. Displacement of at least a portion of the fluid from the hollow interior of the body into the indicator due to the one or more items being placed on the body of the bladder repositions the movable component of the indicator to indicate the fullness of the shelf with the one or more items. The fluidic connection between the hollow interior of the body and the indicator defines a closed system.

In another embodiment, an exemplary item monitoring system is provided that includes a bladder configured to be positioned on a supporting surface of a shelf and further configured to receive one or more items thereon. The bladder includes a body that includes a hollow interior configured to be filled with a fluid. The item monitoring system includes an indicator fluidly connected to the hollow interior of the body of the bladder. The indicator includes a movable component configured to indicate a fullness of the shelf with the one or more items in a non-electrical manner. Displacement of at least a portion of the fluid from the hollow interior of the body into the indicator due to the one or more items being placed on the body of the bladder repositions the movable component of the indicator to visually indicate the fullness of the shelf with the one or more items. The fluidic connection between the hollow interior of the body and the indicator defines a closed system. The item monitoring system includes an image capture device configured to detect a position of the movable component of the indicator to determine the fullness of the shelf with the one or more items.

In another embodiment, an exemplary method of monitoring items on a shelf including a supporting surface is provided. The method includes positioning a bladder on the supporting surface of the shelf. The bladder includes a body that includes a hollow interior configured to be filled with a fluid. The method includes detecting with an image capture device a movement of a movable component of an indicator fluidly connected to the hollow interior of the body of the bladder. The method includes identifying a change in items on the shelf based on the detected movement. Positioning one or more items on the bladder displaces at least a portion of the fluid from the hollow interior of the body into the indicator causing the movement of the movable component of the indicator. The fluidic connection between the hollow interior of the body and the indicator defines a closed system.

It should be appreciated that other combinations and/or permutations of embodiments are envisioned as also being within the scope of the present invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed inventory monitoring systems and methods, reference is made to the accompanying figures. The accompanying figures, which are incorporated in and constitute a part of this specification, illustrate one or more embodiments of the invention and, together with the description, help to explain the invention. In the figures:

FIG. 1 is a block diagram of an exemplary item monitoring system in an embodiment.

FIG. 2 is a diagrammatic side view of an exemplary item monitoring system in an embodiment.

FIG. 3 is a diagrammatic side view of an exemplary item monitoring system in an embodiment.

FIGS. 4A and 4B are diagrammatic detailed view of an exemplary indicator of an item monitoring system in an embodiment.

FIG. 5 is a block diagram of an exemplary computing device in an embodiment.

FIG. 6 is a block diagram of an exemplary item monitoring system environment in an embodiment.

FIG. 7 is a flowchart illustrating an exemplary implementation of an item monitoring system in an embodiment.

### DETAILED DESCRIPTION

It should be understood that certain relative terminology used herein, such as, but not necessarily limited to, “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present disclosure. In addition, it should be understood that the scope of the present disclosure is not limited to embodiments having specific dimensions. Thus, any dimensions provided herein are for an exemplary purpose and are not intended to limit the invention to embodiments having particular dimensions.

Inventory on shelving is generally monitored manually by individuals to determine whether additional items need to be added to a particular shelf. Although shelf sensors and video analytics are available in the industry to electronically monitor inventory on shelving, such options generally involve high overhead costs for equipment and data processing, and require an external power source that continuously provides power to the sensors and/or video equipment. Exemplary embodiments of the present invention address these concerns and provide an item monitoring system that provides a closed system for indicating the inventory status of items on a shelf in a non-electrical manner. More particularly, the exemplary item monitoring system includes a bladder configured to be filled with a fluid, and an indicator fluidly connected with the bladder that includes a movable component configured to visually indicate a fullness or inventory of the shelf. As will be discussed in greater detail below, displacement of the fluid from the bladder into an elongated tube of the indicator moves the movable component to a position which indicates the inventory status of the shelf. Thus, the indicator can provide the inventory status in a non-electrical manner based solely on displacement of the fluid from the bladder.

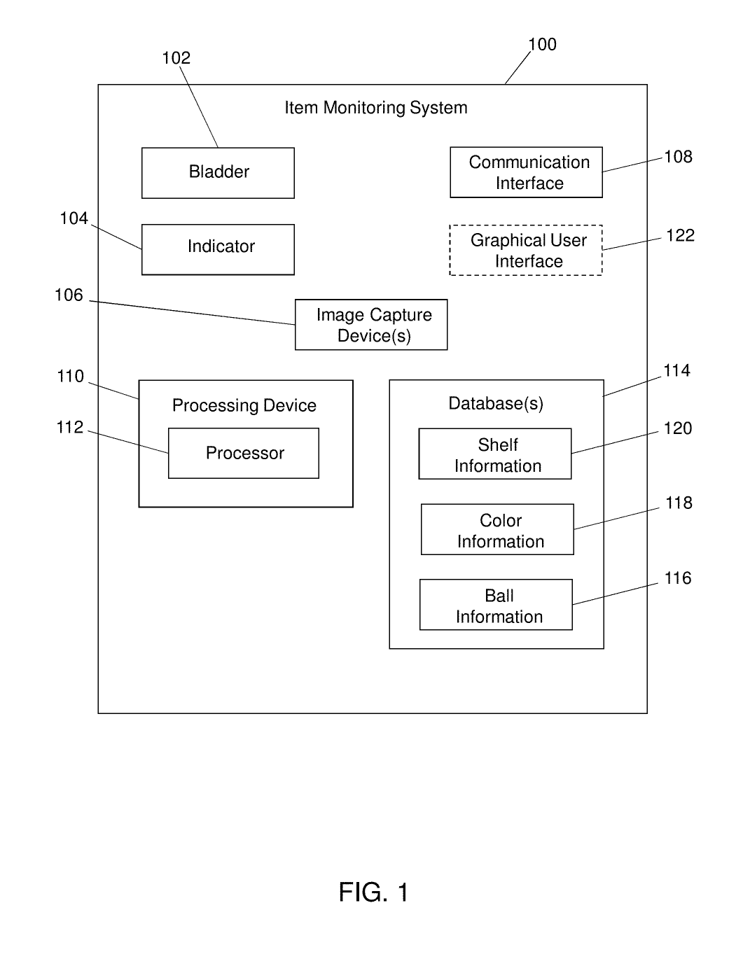

FIG. 1 is a block diagram of an item monitoring system 100 (hereinafter “system 100”) in accordance with exemplary embodiments. The system 100 includes a bladder 102 configured to be positioned on a supporting surface of a shelf. In one embodiment, the bladder 102 can be positioned on the supporting surface of the shelf and one or more items can be positioned directly on the bladder 102. In another embodiment, the bladder 102 can be positioned on the supporting surface of the shelf, an item supporting surface of the shelf can be positioned on the bladder 102, and one or more items can be positioned on the item supporting surface. The bladder 102 can thereby directly or indirectly support one or more items thereon.

The bladder 102 can define an elongated and substantially planar configuration, such that the planar configuration of the shelf is unaffected for support of the items. The bladder 102 includes a body with a bottom planar surface configured to be positioned on the supporting surface of the shelf, and a planar top surface configured to receive (directly or indirectly) the items thereon. In general, the bladder 102 can be fabricated from a flexible material (e.g., a rubber material, or the like). The body of the bladder 102 includes a hollow interior configured to be filled with a fluid, such as air or liquid. The bladder 102 can include an opening into the hollow interior for introduction of the fluid into the hollow interior, thereby at least partially inflating the bladder 102.

The system 100 includes an indicator 104 fluidly connected to the hollow interior of the body of the bladder 102. In one embodiment, the indicator 104 can include a hollow, elongated tube with an interior passage and a movable component (e.g., a ball) movably disposed within the interior passage. A distal end of the interior passage can be fluidly connected to the hollow interior of the bladder, while a proximal end of the interior passage can be closed to prevent escape of the fluid from the system 100 (e.g., a closed system). The elongated tube can extend substantially diagonally or at an angle relative to the substantially horizontal orientation of the shelf (e.g., the horizontal plane defined by the planar top surface and/or the shelf). In some embodiments, the elongated tube can be located at or near the front edge of the shelf for clear visualization by an individual and/or an image capture device.

Placing one or more items directly or indirectly on the bladder 102 creates a compression force on the body of the bladder 102. The compression force causes displacement of at least a portion of the fluid from the hollow interior of the body into the interior passage of the elongated tube. Displacement of the fluid from the bladder 102 into the interior passage of the elongated tube of the indicator 104 moves the movable component within the elongated tube (e.g., a first type of movement) to visually indicate a fullness of the shelf with one or more items in a non-electrical manner.

The amount of movement of the movable component within the elongated tube can be calibrated to the pressure within the bladder 102. For example, when no items are positioned on the bladder 102, the movable component can be at or near the distal end of the interior passage (e.g., a bottommost section indicating an empty shelf or inventory) due to the lack of or minimum amount of displaced fluid from the bladder 102 to the elongated tube. As a further example, when the maximum allotted number of items is positioned on the bladder 102, the movable component can be moved by the displaced fluid to a point at or near the proximal end of the interior passage (e.g., the topmost section indicating a full shelf or inventory). As a further example, when a number of items between zero and the maximum allotted number is positioned on the bladder 102, the movable component can be moved by the displaced fluid to a point between the proximal and distal ends of the interior passage.

Removing one or more items from the bladder 102 removes the compression force from the bladder 102, thereby causing displacement of at least a portion of the fluid from the interior passage of the elongated tube to the hollow interior of the bladder 102. Displacement of the fluid from the elongated tube to the bladder 102 reduces the amount of fluid force on the movable component within the elongated tube, allowing the movable component to move to a lower position along the length of the elongated tube (e.g., a second type of movement) corresponding to the number of items removed from the bladder 102.

In one embodiment, the bladder 102 can be filled with air and the elongated tube can include air between the movable component and the proximal end of the elongated tube (e.g., the same fluid on either side of the movable component). In another embodiment, the bladder 102 can be filled with liquid and the elongated tube can include air between the movable component and the proximal end of the elongated tube (e.g., different fluids on either side of the movable component). The movable component can act as a seal between the movable component and the interior sides of the elongated tube, thereby preventing or limiting passage of the fluid around the movable component. Thus, when the fluid is displaced from the bladder 102 into the elongated tube, the movable component is moved by the displaced fluid in an accurate and calibrated manner. In some embodiments, the movable component can be in the form of a ball that floats on the liquid displaced from the bladder 102 to indicate the inventory status of the shelf.

In another embodiment, the indicator 104 can include a spinner assembly including a spinner body with an interior passage fluidly connected to the hollow interior of the bladder 102. The spinner assembly includes a spinner rotatably disposed within the spinner body. A surface of the spinner body includes radially disposed sections or surfaces each having a different color corresponding with a level of fullness of the shelf. In an embodiment, the spinner body includes a transparent surface through which the spinner is visible, such that radial alignment of the spinner with one of the colors provides a visual indication of the fullness of the shelf. In an embodiment, the spinner assembly includes an opening formed in the spinner body through which a single one of the radially disposed sections or surfaces is visible at one time.

Placing the one or more items on the body of the bladder 102 creates a compression force on the bladder 102. The compression force causes displacement of at least a portion of the fluid from the hollow interior of the bladder 102 into the interior passage of the spinner body. Removal of one or more items from the bladder 102 removes the compression force from the bladder 102, thereby causing displacement of at least a portion of the fluid from the interior passage of the spinner body to the hollow interior of the bladder 102. The radial position of the spinner within the spinner body is affected by the amount of the fluid displaced from the hollow interior of the bladder 102 into the interior passage of the spinner body and changes position accordingly.

Each of the different colors of the sections of the spinner body corresponds to a level of the fullness of the shelf with one or more items. For example, when no items are positioned on the bladder 102, the spinner position can be radially positioned to align with a red section of the spinner body (e.g., indicating an empty shelf or inventory) due to the lack of or minimum amount of displaced fluid from the bladder 102 to the spinner body. As a further example, when the maximum allotted number of items is positioned on the bladder 102, the spinner can be radially spun or moved by the displaced fluid to a position aligned with a green section of the spinner body (e.g., indicating a full shelf or inventory). As a further example, when a number of items between zero and the maximum allotted number is positioned on the bladder 102, the spinner can be radially spun or moved by the displaced fluid to a position aligned with a yellow section of the spinner body. Alignment of the spinner with the different colors provides a visual for an individual and/or an image capture device to determine the inventory status of the shelf.

In another embodiment, the indicator 104 can include a gear and complementary geared tracks disposed within the hollow interior of the bladder 102. One geared track can be mechanically connected to the inner portion of the top surface of the bladder 102, and the other geared track can be mechanically connected to the inner portion of the bottom surface of the bladder 102. The gear and track assembly can be electrically connected to a sensor (e.g., an electrical sensor) that measures displacement of the geared tracks relative to a starting position. The starting position can correspond to, e.g., an empty shelf, a full shelf, or the like.

Placing one or more items on the bladder 102 generates a compression force that forces the top and bottom surfaces of the bladder 102 toward each other, thereby moving the geared tracks toward each other. As the geared tracks are translated, meshing of the tracks with the gear transmits a rotational force on the gear. The sensor detects rotation of the gear and/or movement of the geared tracks and, based on the magnitude of rotation or movement determines the corresponding change in inventory on the shelf.

Removing one or more items from the bladder 102 reduces the compression force, allowing the top and bottom surfaces of the bladder 102 to move away from each other, thereby moving the geared tracks away from each other. Movement of the tracks actuates rotation of the gear. The sensor detects rotation of the gear and/or movement of the geared tracks and, based on the magnitude of rotation or movement, determines the corresponding change in inventory on the shelf.

In some embodiments, the system 100 can include one or more image capture devices 106 (e.g., photographic cameras, video cameras, combinations thereof, or the like). The image capture device 106 can be oriented to have a visual of the indicator 104 associated with one or more shelves. Thus, when the displaced fluid actuates the indicator to move the movable component or rotate the spinner, the image capture device 106 can be configured to detect the position of the movable component within the elongated tube or the color visible on the spinner body as aligned with the spinner.

The system 100 can include a communication interface 108 and a processing device 110 including a processor 112. The communication interface 108 can be used to electronically transmit the position of the movable component or the color of the spinner body aligned with the spinner as detected by the image capture device 106 from the image capture device 106 to the processing device 110. In some embodiments, the communication interface 108 can electronically transmit the position of the movable component detected by the image capture device 106 from the image capture device 106 to a database 114 including ball information 116. The ball information 116 can include the different positions of the movable component within the elongated tube and the corresponding inventory status of the shelf.

In some embodiments, the communication interface 108 can electronically transmit the color of the spinner body aligned with the spinner as detected by the image capture device 106 from the image capture device 106 to the database 114 including color information 118. The color information 118 can include the different colors of the spinner body and the corresponding inventory status of the shelf. The database 114 can include shelf information 120, such as the location of the shelf within a retail environment, the items disposed on a particular shelf and/or bin, the location of the image capture device 106, combinations thereof, or the like.

The detected indication from the indicator 104 can be processed by the processing device 110 to determine the inventory status of the shelf, and the communication interface 108 can electronically transmit a notification to an electronic device (e.g., a handheld electronic device, a smart electronic device, or the like) regarding the inventory status of the shelf. For example, the notification can provide information regarding the location of the shelf, the item(s) disposed on the shelf, the level of fullness of the shelf, the need for restocking of one or more times, combinations thereof, or the like. In some embodiments, the electronic device includes a graphical user interface (GUI) 122 for displaying the notification to a user. Based on the notification, an individual can restock the appropriate shelf with the appropriate items.

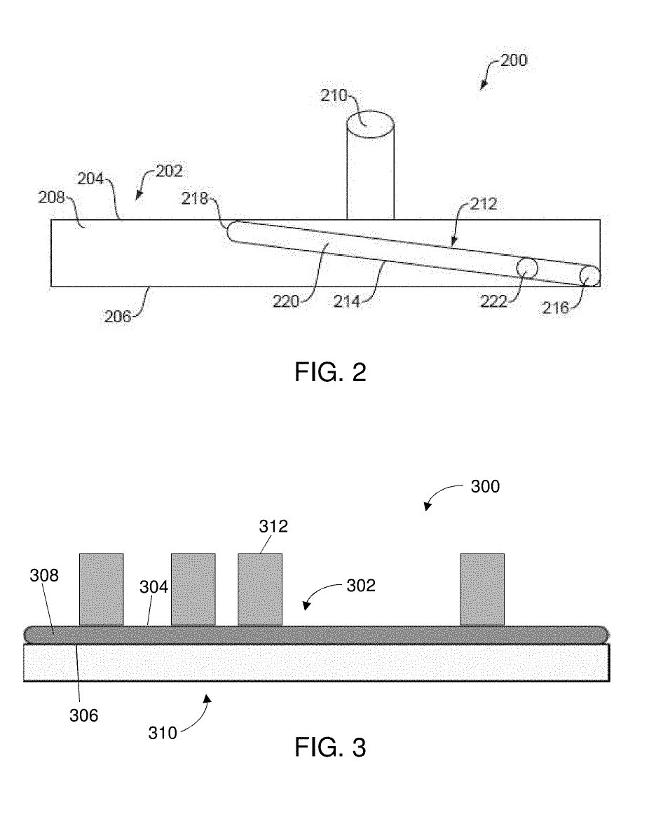

FIG. 2 is a diagrammatic side view of an item monitoring system 200 (hereinafter “system 200”) in accordance with exemplary embodiments. The system 200 can be substantially similar in structure and function to the system 100, except of the distinctions noted herein. The system 200 includes at least one bladder 202 that can be disposed on a shelf. The bladder 202 generally defines a bottom, substantially planar surface 206 and a top, substantially planar surface 204. Between the top and bottom surfaces 204, 206, the bladder 202 includes a hollow interior 208 configured and dimensioned to be at least partially filled with a fluid.

In some embodiments, the top surface 204 defines a supporting surface on which one or more items 210 can be positioned (e.g., directly positioning the items 210 on the bladder 202). In some embodiments, the bottom surface 206 of the bladder 202 can be positioned on a first shelf portion, and a second shelf portion can be positioned on the top surface 204 of the bladder 202 to substantially cover the bladder 202 and position the bladder 202 between the first and second shelf portions. In such embodiments, the items 210 can be positioned on the item supporting surface of the second shelf portion (e.g., indirectly positioning the items 210 on the bladder 202). Fluctuations in compression forces on the bladder 202 occur based on items 210 placed on or removed from the bladder 202 or the second shelf portion.

The system 200 includes an indicator 212 including an elongated tube 214 with a distal end 216 and a proximal end 218. The elongated tube 214 extends at an angle (e.g., diagonally) relative to the substantially horizontal orientation of the bladder 202 or shelf on which the bladder 202 is positioned, with the distal end 216 positioned at a low point of the indicator 212 and the proximal end 218 positioned at a high point of the indicator 212. The elongated tube 214 includes an interior passage 220 in which a movable component 222 (e.g., a ball) is movable disposed. The distal end 216 of the interior passage 220 is fluidly connected to the hollow interior 208 of the bladder 202 such that fluid can be displaced from the bladder 202 into the elongated tube 214 and from the elongated tube 214 into the bladder 202. The proximal end 218 is capped or closed to prevent escape of the fluid from the system 200, thereby defining a closed system.

As described above, depending on the amount of fluid displaced from the bladder 202 and into the elongated tube 214, the movable component 222 is caused to move along the length of the elongated tube 214 between the distal and proximal ends 216, 218. The proximal end 218 corresponds with a full inventory of items 210 positioned on the bladder 202 with a maximum compression force imparted on the bladder 202. The distal end 216 corresponds with an empty inventory of items 210 (e.g., zero items 210) positioned on the bladder 202 and a minimum or no compression force imparted on the bladder 202. With no compression force imparted on the bladder 202 and no displaced fluid entering the elongated tube 214, gravity forces the movable component 222 to move towards the distal end 216. The position of the movable component 222 along the length of the elongated tube 214 thereby indicates the inventory status of the shelf that can be visualized by an individual and/or an image capture device.

FIG. 3 is a diagrammatic side view of an item monitoring system 300 (hereinafter “system 300”) in accordance with exemplary embodiments. The system 300 can be substantially similar in structure and function to the system 100, 200, except of the distinctions noted herein. The system 300 includes at least one bladder 302 that can be disposed on a shelf 310. The bladder 302 generally defines a bottom, substantially planar surface 306 and a top, substantially planar surface 304. Between the top and bottom surfaces 304, 306, the bladder 302 includes a hollow interior 308 configured and dimensioned to be at least partially filled with a fluid. In some embodiments, the top surface 304 defines a supporting surface on which one or more items 312 can be positioned. Although FIG. 3 does not illustrate the indicator, it should be understood that an indicator can be fluidly connected to the bladder 302.

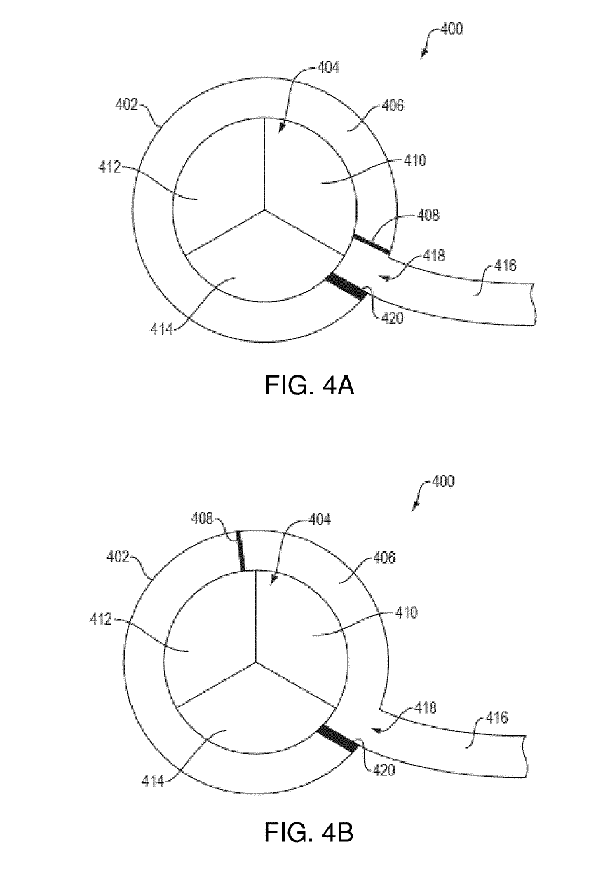

FIGS. 4A and 4B are diagrammatic detailed view of an indicator 400 in the form of a spinner assembly for an item monitoring system. The indicator 400 includes a spinner body 402 with a central area 404 surrounded by a hollow, interior passage 406. The indicator 400 includes a spinner 408 rotatably disposed within the interior passage 406 of the spinner body 402. The spinner 408 can define a shape configured to substantially block the interior passage 406 while allowing the spinner 408 to rotate and radially move along the interior passage 406. The central area 404 around which the spinner 408 rotates or moves includes two or more radially disposed sections 410, 412, 414 each having a different color (e.g., green, red, yellow, or the like) corresponding to specific compression forces on the bladder.

A connector 416 (e.g., a tube or pipe) fluidly connects the interior passage 406 with the hollow interior of the bladder. The interior passage 406 extends from an inlet 418, around the central area 404, and up to a closed end 420 adjacent to the inlet 418. Fluid displaced from the bladder entering the interior passage 406 imparts a force on the spinner 408, and axially rotates the spinner 408 within the spinner body 402 by a predetermined radial distance based on the compression force on the bladder. The spinner body 402 can be substantially transparent along the area covering the interior passage 406 such that the position of the spinner 408 is visible. Thus, based on the compression force on the bladder due to items positioned on the bladder, the displaced fluid axially rotates the spinner 408 to align the spinner 408 with a corresponding section 410, 412, 414. For example, section 410 can be red and corresponds to a low number of items on the bladder, section 412 can be yellow and corresponds to a medium number of items on the bladder, and section 414 can be green and corresponds to a large number of items on the bladder.

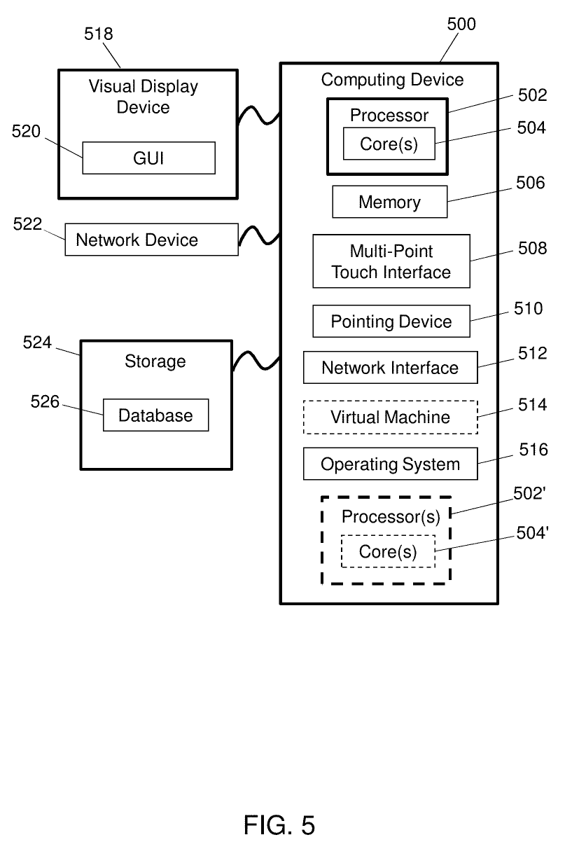

FIG. 5 is a block diagram of a computing device 500 in accordance with exemplary embodiments. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the present disclosure (e.g., instructions for controlling the image capture device 106, the communication interface 108, the processing device 110, combinations thereof, or the like). The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device 500 may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518 (e.g., a personal computer, a mobile smart device, or the like), such as a computer monitor, which may display one or more user interfaces 520 (e.g., GUI 122) that may be provided in accordance with exemplary embodiments. The computing device 500 may include other I/O devices for receiving input from a user, for example, a keyboard or any suitable multi-point touch interface 508, a pointing device 510 (e.g., a mouse). The keyboard 508 and the pointing device 510 may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement one or more portions of the system 100, such as the image capture device 106, or the like. Exemplary storage device 524 may also store one or more databases 526 for storing any suitable information required to implement exemplary embodiments. For example, exemplary storage device 524 can store one or more databases 526 for storing information, such as data relating to the shelf information 120, color information 118, the ball information 116, or the like, and computer-readable instructions and/or software that implement exemplary embodiments described herein. The databases 526 may be updated by manually or automatically at any suitable time to add, delete, and/or update one or more items in the databases.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 500 may run an operating system 516, such as versions of the Microsoft® Windows® operating systems, the different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 516 may be run in native mode or emulated mode. In an exemplary embodiment, the operating system 516 may be run on one or more cloud machine instances.

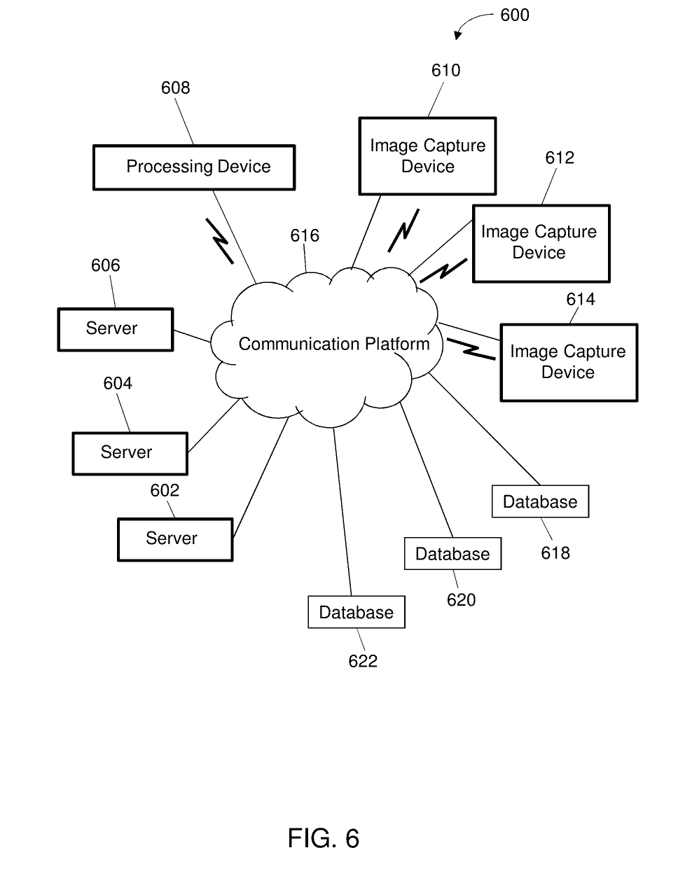

FIG. 6 is a block diagram of an exemplary sensing or item monitoring system environment 600 in accordance with exemplary embodiments of the present disclosure. The environment 600 can include servers 602, 604, 606 operatively coupled to a processing device 608, and image capture devices 610, 612, 614, via a communication platform 616, which can be any network over which information can be transmitted between devices communicatively coupled to the network. For example, the communication platform 616 can be the Internet, Intranet, virtual private network (VPN), wide area network (WAN), local area network (LAN), and the like. In an embodiment, the communication platform 616 can be part of a cloud environment. The environment 600 can include repositories or databases 618, 620, 622, which can be operatively coupled to the servers 602, 604, 606, as well as to the processing device 608, and image capture devices 610, 612, 614, via the communications platform 616.

In exemplary embodiments, the servers 602, 604, 606, processing device 608, image capture devices 610, 612, 614, and databases 618, 620, 622 can be implemented as computing devices (e.g., computing device 500). Those skilled in the art will recognize that the databases 618, 620, 622 can be incorporated into one or more of the servers 602, 604, 606 such that one or more of the servers 602, 604, 606 can include databases 618, 620, 622. In an embodiment, the database 618 can store the ball information 116, the database 620 can store the color information 118, and the database 622 can store the shelf information 120. In an embodiment, a single database 618, 620, 622 can store the ball information 116, color information 118, and shelf information 120.

In an embodiment, embodiments of the servers 602, 604, 606 can be configured to implement one or more portions of the system 100. For example, server 602 can be configured to implement one or more portions of the image capture device 106. As a further example, server 604 can be configured to implement one or more portions of the communication interface 108.

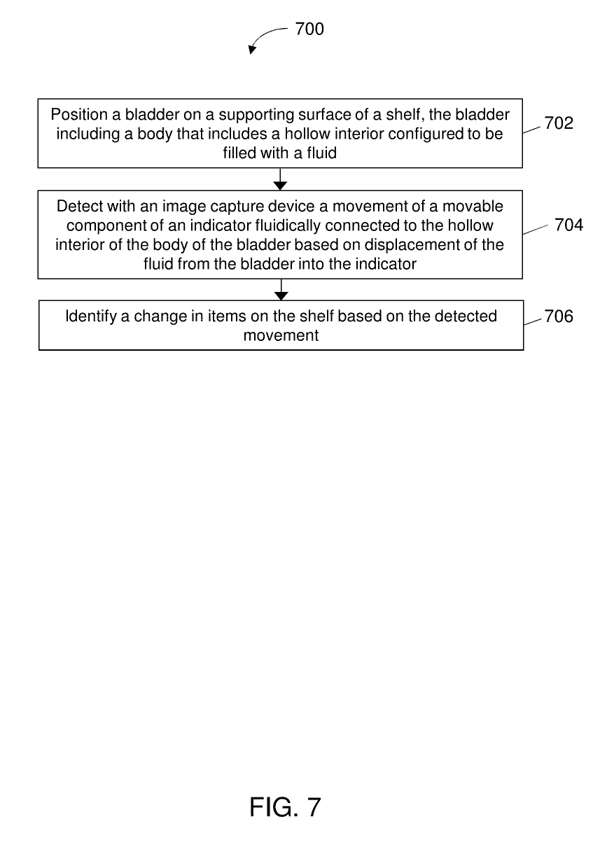

FIG. 7 is a flowchart illustrating an exemplary process 700 as implemented by the item monitoring system 100. To begin, at step 702, a bladder is positioned on a supporting surface of a shelf. The bladder includes a body that includes a hollow interior configured to be filled with a fluid. At step 704, a movement of a movable component of an indicator fluidly connected to the hollow interior of the body of the bladder is detected with an image capture device based on displacement of the fluid from the bladder the indicator. At step 706, a change in items on the shelf is identified based on the detected movement.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An item monitoring system, comprising:
a bladder configured to be positioned on a supporting surface of a shelf and further configured to receive one or more items thereon, the bladder including:
a body that includes a hollow interior configured to be filled with a fluid; and
an indicator fluidly connected to the hollow interior of the body of the bladder, the indicator including a movable component configured to visually indicate a fullness of the shelf with the one or more items in a non-electrical manner;
wherein displacement of at least a portion of the fluid from the hollow interior of the body into the indicator due to the one or more items being placed on the body of the bladder repositions the movable component of the indicator to indicate the fullness of the shelf with the one or more items; and
wherein the fluidic connection between the hollow interior of the body and the indicator defines a closed system.

2. The item monitoring system of claim 1, wherein the bladder defines an elongated and planar configuration.

3. The item monitoring system of claim 1, wherein the body of the bladder includes a bottom planar surface configured to be positioned on the supporting surface of the shelf, and a planar top surface configured to receive the one or more items thereon.

4. The item monitoring system of claim 1, wherein the bladder is fabricated from a flexible material.

5. The item monitoring system of claim 1, wherein the fluid is at least one of air or liquid.

6. The item monitoring system of claim 1, wherein the indicator comprises an elongated tube including an interior passage, and the movable component of the indicator comprises a ball movably disposed within the interior passage.

7. The item monitoring system of claim 6, wherein the interior passage of the elongated tube is fluidly connected to the hollow interior of the body.

8. The item monitoring system of claim 6, wherein the elongated tube is oriented diagonally relative to a horizontal orientation of the shelf.

9. The item monitoring system of claim 6, wherein placing the one or more items on the body of the bladder creates a compression force on the body causing the displacement of at least a portion of the fluid from the hollow interior of the body into the interior passage of the elongated tube.

10. The item monitoring system of claim 9, wherein removal of the one or more items from the body of the bladder removes the compression force from the body causing displacement of at least a portion of the fluid from the interior passage of the elongated tube to the hollow interior of the body.

11. The item monitoring system of claim 6, wherein a position of the ball within the elongated tube relative to a proximal end and a distal end of the elongated tube is affected by an amount of the fluid displaced from the hollow interior of the body into the interior passage of the elongated tube.

12. The item monitoring system of claim 6, wherein the fluid within the hollow interior of the body is a liquid, a distal end of the elongated tube of the indicator is fluidly connected to the hollow interior of the body, and the fluid within the elongated tube between the ball and a proximal end of the elongated tube is air.

13. The item monitoring system of claim 1, wherein the indicator comprises:
a spinner assembly including a spinner body with an interior passage,
a spinner rotatably disposed within the spinner body, a surface of the spinner body including radially disposed sections each having a different color.

14. The item monitoring system of claim 13, wherein the interior passage of the spinner body is fluidly connected to the hollow interior of the body of the bladder.

15. The item monitoring system of claim 13, wherein placing the one or more items on the body of the bladder creates a compression force on the body causing the displacement of at least a portion of the fluid from the hollow interior of the body into the interior passage of the spinner body.

16. The item monitoring system of claim 15, wherein removal of the one or more items from the body of the bladder removes the compression force from the body causing displacement of at least a portion of the fluid from the interior passage of the spinner body to the hollow interior of the body.

17. The item monitoring system of claim 13, wherein a radial position of the spinner within the spinner body is affected by an amount of the fluid displaced from the hollow interior of the body into the interior passage of the spinner body.

18. The item monitoring system of claim 13, wherein each of the different colors of the sections of the spinner corresponds to a level of the fullness of the shelf with the one or more items.

19. An item monitoring system, comprising:
a bladder configured to be positioned on a supporting surface of a shelf and further configured to receive one or more items thereon, the bladder including:
a body that includes a hollow interior configured to be filled with a fluid;
an indicator fluidly connected to the hollow interior of the body of the bladder, the indicator including a movable component configured to indicate a fullness of the shelf with the one or more items in a non-electrical manner;
wherein displacement of at least a portion of the fluid from the hollow interior of the body into the indicator due to the one or more items placed on the body of the bladder repositions the movable component of the indicator to visually indicate the fullness of the shelf with the one or more items; and
wherein the fluidic connection between the hollow interior of the body and the indicator defines a closed system; and
an image capture device configured to detect a position of the movable component of the indicator to determine the fullness of the shelf with the one or more items.

20. A method of monitoring items on a shelf including a supporting surface, the method comprising:
positioning a bladder on the supporting surface of the shelf, the bladder including:
a body that includes a hollow interior configured to be filled with a fluid;
detecting with an image capture device a movement of a movable component of an indicator fluidly connected to the hollow interior of the body of the bladder; and
identifying a change in items on the shelf based on the detected movement,
wherein positioning one or more items on the bladder displaces at least a portion of the fluid from the hollow interior of the body into the indicator causing the movement of the movable component of the indicator; and
wherein the fluidic connection between the hollow interior of the body and the indicator defines a closed system.
